(19) United States
(12) Patent Application Publication
(10) Pub. No.: US 2009/0269440 A1
(43) Pub. Date: Oct. 29, 2009

(54) COMPOSITIONS INCREASING MOISTURE CONTENT AND DISTRIBUTION IN MUSCLE-DERIVED FOOD PRODUCTS

(75) Inventor: Richard B. Hardin, Watkinsville, GA (US)

Correspondence Address: Pabst Patent Group LLP, 1545 PEACHTREE STREET NE, SUITE 320, ATLANTA, GA, 30309, US

(73) Assignee: Genesis Global Limited

(21) Appl. No.: 12/429,615

(22) Filed: Apr. 24, 2009

Related U.S. Application Data
(60) Provisional application No. 61/125,295, filed on Apr. 24, 2008.

(51) Int. Cl. A23L 1/30; A23J 1/02; A23J 1/04; C11B 5/00

(52) U.S. Cl. 426/72; 426/442; 426/657; 426/615; 426/542

(57) ABSTRACT

Methods for making dry protein powder or aqueous functional protein suspension compositions which provide increased moisture content and moisture retention in meats and other animal muscle tissue-based products have been developed. An important aspect is the use of alkali rather than an acid or a series of acid and alkaline treatments to dissolve the protein in the starting material. This includes both muscle and connective tissue proteins and fats, yielding a product in higher yield than acid based and other processes in which fat and connective tissue is removed and then only the remaining muscle dissolved in the acid. The connective tissue and fat increases water retention in meat into which it is injected, as compared to meat extracts containing only muscle proteins.

### CROSS REFERENCE TO RELATED APPLICATIONS

This application claims priority to U.S. Ser. No. 61/125,295, filed Apr. 24, 2008.

### FIELD OF THE INVENTION

The present disclosure relates, generally, to the industrial treatment of animal muscle-derived food products such as meat, fish, and poultry. More specifically, compositions and methods for improving moisture content and distribution in meat and other animal-based protein products have been developed. The compositions are prepared using a single alkaline treatment process rather than a process using acid or a combination or acid and alkaline to yield a meat particle product that includes muscle and connective tissue protein as well as fat. The process is more economical due to fewer steps and has higher yield due to less fat and connective tissue being discarded. Connective tissue and fat in the final product increase water retention and improve organoleptic characteristics in meat treated with the product.

### BACKGROUND OF THE INVENTION

Supplementation of meat, seafood, and poultry products is used by the food industry for such purposes as improving flavor and moisture retention, increasing nutritional value, and reducing fat absorption during cooking. Current industrial methods for supplementation of raw and prepared meat products typically involve marinating, injecting, soaking, tumbling, or otherwise adding to meat such materials as water, salt, and/or phosphates.

Phosphates are commonly used in the meat industry to raise the pH of the meat to increase the water holding capacity of the protein fibers. One such process is described in U.S. Pat. No. 4,818,528 to Green, et al., for treating and packing fresh meat to retain the fresh meat color of the meat and to postpone microbial deterioration and spoilage of the meat. However, phosphate treatments have a tendency to diminish texture, appearance and flavor in meat products. Meats that have undergone phosphate treatments are commonly known in the meat industry as being “over-processed” or having a “processed” look and/or taste.

U.S. Published Application No. 2004/0219283 by Evans describes the use of trehalose to treat uncooked meat in order to decrease shrinkage during cooking. The use of sodium bicarbonate in the meat treatment industry has also been reported. Sodium bicarbonate is injected into meat products to improve the color, water retention, and organoleptic properties of the meat. U.S. Pat. No. 7,060,309 to Paterson, et al., describes the use of sodium bicarbonate under vacuum to reduce the number of holes in subsequently cooked meat. U.S. Pat. No. 6,020,012 to Kaufman, et al. describes the use of sodium bicarbonate as an injectable treatment to reduce the rate of pH decline

These industrial methods are, however, becoming progressively less acceptable to consumers and hence manufacturers. Consumers generally perceive the ingestion of “chemical” additives as unhealthy and the healthcare profession has, in fact, determined that the high sodium levels used in many of these systems are highly detrimental to consumer health. In some cases, the sodium increase (above the original salinity of untreated meat) can be as much as 500% per serving. Although this water loss can be reduced by including starch or other vegetable matter during processing, these ingredients tend to alter flavors and textural characteristics.

An alternative industrial approach to meat supplementation utilizes edible protein compositions derived from animal muscle and associated tissues. The Cozzini process injects into the target meat, a mixture of finely ground meat particles, salts, and, in some applications, phosphates. (SuspenTec®, Cozzini Inc., http://www.cozzini.com, Chicago, Ill.). A problem that may occur in this process is that bacteria that is present in the trim is introduced into the aerated suspension and then carried into the interior of the muscle during the process, decreasing shelf life due to increased microbiological activity and rancidity.

Other processes, by contrast, involve separating out connective tissue mechanically, then dissolving animal muscle protein at either high or low pH, followed by precipitation and de-watering of the dissolved proteins. U.S. Pat. Nos. 6,085,073, 6,288,216 and 6,451,975 to Hultin, et al., International Publication Nos. WO/99/11656, WO 01/05251 and U.S. Published Application No. 2007/0276127 by Hultin, et al. describe a process for isolating a protein component of animal muscle tissue by mixing a particulate form of the tissue with an acidic aqueous liquid having a pH below about 3.5 to produce a protein substantially free of myofibrils and sarcomere structure. U.S. Pat. No. 6,136,959, to Hultin, et al. and U.S. Published Application Nos. 2004/0067551, 2005/0287285 by Hultin, et al. describe a process for isolating edible protein from animal muscle by solubilizing the protein in an alkaline aqueous solution. International Publication No. WO 2007/046891 describes a system for separating proteins from connective tissue. However, the low pH to which proteins are exposed can greatly accelerate oxidation and rancidity. Furthermore, many water soluble proteins, non-protein soluble nutrients, and small particles are lost in the de-watering phase.

Thus there is still a need for improved compositions and methods for increasing the moisture content, uniform moisture distribution, and moisture retention in animal muscle tissue-based food products, including meats, seafood, and poultry, while maintaining a healthful sodium level.

It is therefore an object of the invention to provide a composition, and economical method for making, for increasing moisture content of animal muscle tissue-based food products using muscle derived compositions with high yield from starting material.

It is a still further object of this invention to provide a composition and method for increasing the moisture content of animal muscle-tissue based product that results in uniform moisture distribution and moisture retention.

### SUMMARY OF THE INVENTION

Methods for making dry protein powder or aqueous functional protein suspension compositions which provide increased moisture content and moisture retention in meats and other animal muscle tissue-based products have been developed. An important aspect is the use of alkali rather than acid to dissolve the protein in the starting material. This includes both muscle and connective tissue proteins and fats, yielding a product in higher yield than acid based and other processes in which connective tissue is removed and then only the remaining muscle dissolved in the acid. The connective tissue and fat increases water retention and organoleptic properties in meat into which it is injected, as compared to meat extracts containing only muscle proteins. In the preferred embodiment, the process does not include a step in which the connective tissue is removed, but only minced, diced or micronized for subsequent dissolution in alkali solution. This also decreases processing steps and therefore costs. The composition is useful in increasing value of meat, especially very lean or low value trim, into which it is injected since it can be used to selectively increase water retention as well as juiciness due to the inclusion of the fat.

In one embodiment, the method for preparing an alkaline aqueous functional protein suspension (AFPS) includes the steps of: (a) mixing a source animal muscle tissue with water; (b) high shear chopping, grinding, emulsifying, and/or mincing the source animal muscle tissue of step (a) to generate an aqueous functional protein suspension (AFPS) which includes muscle, connective tissue and fat; (c) adding water to adjust the solids concentration of the AFPS of step (b) to between about 2% and about 7% protein on a mass-to-mass basis; and (d) alkalinizing the AFPS of step (c) with a strong (i.e., concentrated) base to a pH above that of the native source animal muscle tissue. Undissolved connective tissue is optionally removed by filtering, screening, or other method before or after alkalinizing step.

The resulting AFPS can be sold, stored, or used directly. Alternatively, it can be converted to a dry protein powder (DPP) by drying the AFPS. The powder can then be resuspended in water for use as a suspension or injected/applied/administered as a solid.

### DETAILED DESCRIPTION OF THE INVENTION

### I. Definitions

As used herein, the term “aqueous functional protein suspension” or “AFPS” includes an aqueous suspension of a source animal muscle tissue and associated tissues. This includes muscle and connective tissue proteins as well as fat. The compositions will depend on the starting materials, as well as alkali concentration and time of treatment.

As used herein, the term “meaf” includes all muscle tissue derived from a mammal including, but not limited to cattle, pig, sheep, deer, elk, and rabbit.

As used herein, the term “animal muscle tissue” includes all muscle tissue, including meat, derived from a reptile, a mammal, a seafood, and poultry.

As used herein, the term “source animal muscle tissue” includes the muscle tissue, including meat, from which protein is extracted for the preparation of AFPS.

As used herein, the term “target animal muscle tissue” includes the muscle tissue, including meat, to which an AFPS is applied.

As used herein, the term “dry protein powder” or “DPP” includes dried AFPS and, optionally, one or more buffer, process aid, and/or salt. When suspended in water, a DPP becomes an AFPS.

As used herein, the term “block” includes any animal muscle tissue product that is frozen under pressure in order to induce adhesion between composite pieces and individual pieces of animal muscle tissue that have been frozen to achieve controlled dimensions and adhesion after thawing.

As used herein, the term “native” includes those components that derive from, are contained within, or pertain to, the original source animal muscle tissue.

As used herein, the term “protein content” includes the percentage, on a dry mass basis, of protein contained in a given amount of a material.

As used herein, the term “buffer” includes a substance, either organic or inorganic in nature, which acts to stabilize the pH of an aqueous solution around a certain target point, which pH is a characteristic of the pH of the buffer itself.

As used herein, the term “protein functionality” includes: (1) the ability to act, in concert with other ingredients, to increase the water holding capacity of an animal muscle tissue; (2) the ability to aid in the dispersion of an AFPS within a target animal muscle tissue; (3) the ability to help preserve the natural texture of a target animal muscle tissue when its water content is increased; and (4) the ability to stabilize an emulsion containing fat or oil and water during freezing, storage, and cooking.

As used herein, the term “application method” includes the injection, tumbling, soaking, or other method that is used to cause the AFPS to become integrally bound to and evenly dispersed within a target animal muscle tissue.

As used herein, the term “salt content” includes, unless otherwise noted herein, the percentage, on a dry mass basis, of salt, most typically NaCl, in a given amount of material.

As used herein, the term “salt” includes, but is not limited to, any salt, organic or inorganic in nature, such as, for example, NaCl.

### II. Methods For Preparing Aqueous Protein Suspensions and Dry Protein Powder

A. Preparation of AFPS

A single-step alkalinization of a source animal muscle tissue is effective in producing an aqueous functional protein suspension (“AFPS”), which, when introduced into meat, seafood, or poultry, enhances the moisture content, moisture retention, and moisture distribution in a target animal muscle tissue such as a meat, seafood, or poultry. It was unexpectedly found that methods employing a single pH shift, in contrast to existing methods employing multiple pH shifts, yield AFPS that retain functionality (i.e., is less damaged) and exhibit higher pickups, less purge loss after injection, and minimize moisture loss during cooking.

An alkaline aqueous functional protein suspension (AFPS) is provided by: (a) mixing a source animal muscle tissue with water; (b) high shear chopping, grinding, emulsifying, and/or mincing the source animal muscle tissue of step (a) to generate an aqueous functional protein suspension (AFPS); (c) adding water to adjust the solids concentration of the AFPS of step (b) to between about 2% and about 7% protein on a mass-to-mass basis; and (d) alkalinizing the ASPS of step (c) with a strong base to a pH above that of the native source animal muscle tissue.

Source Animal Muscle Tissue

Muscle tissue can be obtained from a variety of animal muscle tissues. Representative sources of animal muscle from which AFPS can be prepared include mammalian tissue such as cattle, pig, sheep, deer, elk, and rabbit; fish, such as white fish like cod, flounder, trout, dab, and haddock, or fatty fish such as mackerel, menhaden, bluefish, and herring; krill; shellfish, such as shrimp; poultry such as chicken, turkey, or duck, or reptiles. In a preferred embodiment the source animal muscle tissue is from a mammal.

The muscle tissue can be of any quality, ranging from fit and desirable for animal/human consumption to fit but undesirable for animal/human consumption. In the case of fish, for example, any “high value” meat, e.g., a fillet, that is recovered from the fish can be utilized, as can any portion of the fish left after the fillets have been removed, e.g., heads and frames. As another example, in the case of chicken, breast, wing, and/or thigh meat can be utilized, as can any muscle protein-containing portion of the chicken remaining after high value portions have been removed (e.g. trimmings and/or connective tissue such as silver straps). Similarly, animals that are often considered an undesirable source of food for human consumption can be utilized, e.g., fatty pelagic fish. AFPS can also be obtained from underutilized muscle sources, e.g., Antarctic krill, which is available in large quantities but is difficult to convert to human food because of its small size.

Preparation of an Aqueous Suspension

The source animal muscle tissue is mixed with water in a meat: water ratio that is determined by the process but is usually at least 1:1 on a weight basis, and then chopped, ground, minced, or otherwise reduced in size to small pieces. The size of the animal muscle tissue may optionally be reduced to a microscopic size, as is done in the Cozzini Process. The size of the animal muscle tissue may be reduced using a high shear device such as, for example, a food processor, emulsifier, grinder, or industrial cutter. The high shear chopping or emulsifying will usually take place in a period of 1 to 10 minutes.

In the process water may be added in an amount such that the solids concentration of the AFPS is between about 2% and about 7% protein on a mass-to-mass basis. It will be understood that the precise solids concentration will depend upon the particular application and nature of the source animal muscle tissue employed.

Alkalinization of Aqueous Suspension

The AFPS (optionally, in combination with one or more additive(s)) is alkalinized using a strong base (either in hydrous or anhydrous form) to raise the pH of the mixture to generate an alkaline aqueous functional protein suspension (alkaline AFPS). The pH of the alkaline AFPS is above the native pH of the target protein. Typically, the pH of the alkaline AFPS is between about pH 9 and about pH 13, more typically between about pH 10 and pH 12. For example, the alkaline AFPS may have a pH of about 9, about 9.25, about 9.5, about 9.75, about 10, about 10.25, about 10.5, about 10.75, about 11, about 11.25, about 11.5, about 11.75, about 12, about 12.25, about 12.5, about 12.75, and about 13.

In the preferred embodiment, the base is sodium hydroxide. Food grade bases include metal hydroxides, such as NaOH, Ca(OH)₂, and Ammonium Hydroxide (NH₄OH), metal alkoxides, such as sodium methoxide, sodium ethoxide, sodium propoxide, sodium isopropoxide, or other metal ions (Group I and others); and carbonates and bicarbonates, such as sodium bicarbonate.

As used herein, a strong base refers to a concentrated base equivalent to at least 0.1 M NaOH. The reaction is usually complete by the time the target pH has been reached, usually 3 to 5 minutes.

Undissolved connective tissue may optionally be removed by filtering, screening, or other method before or after alkalinizing step. No treatment with acid is required.

Addition of Food Additives

A food additive such as a fiber, a vitamin, a mineral, a flavoring, an antioxidant, an amino acid, an oil, a weak acid, a weak base, and/or a buffer, a polyphosphate, or a functional ingredient can be added to the AFPS to obtain a desired nutritional and/or flavor profile and/or to achieve mixture performance targets. The food additive may be added before or after the step of alkalinizing. Suitable food additives are known to one of ordinary skill in the art.

B. Preparation of DPP

A dry protein powder (DPP) can be prepared from the AFPS by freeze drying, spray drying, externally fed continuous drum drying, fluidized bed drying, and sonic drying. A DPP may be further processed by grinding to provide a powdered DPP.

In another embodiment, the DPP is prepared by the further step of lowering the pH of the AFPS to between about pH 4.8 and about pH 5.5, for example, between about pH 4.8 and about pH 5 or between about pH 5.2 and about pH 5.5, before drying. This is not preferred, however, since the lowered pH reduces the water holding capacity of the meat in the slurry.

In a further embodiment, a powdered DPP composition comprises a DPP and one or more dry chemical ingredient. The dry chemical ingredient can be an alkaline or other buffer, phosphate, amino acid(s), a strong base (such as NaOH), and/or a salt. Depending upon the precise application contemplated, the powdered DPP may be packaged separately from the dry chemical ingredient or, alternatively, the dry chemical ingredient may be admixed with the powdered DPP.

In some embodiments, the powdered DPP may further comprise a food additive such as fiber, a vitamin, a mineral, a flavoring, an antioxidant, an amino acid, an oil, a weak acid, a weak base, and/or a buffer.

C. Resuspension of DPP to form AFPS

Prior to applying to a target animal muscle tissue, a DPP may be resuspended in water with high speed agitation. During or before this step one or more food additive(s) may be added to the DPP thereof to obtain a desired nutritional and/or flavor profile and/or suitable performance targets.

The powdered DPP composition comprises a strong base such that an alkaline AFPS generated by the addition of water to the powder DPP composition has a pH that is above the native pH of the target protein. For example, the powdered DPP composition may yield an alkaline AFPS having a pH between about pH 9 and about pH 13 or between about pH 10 and about pH 12. Typically, the powdered DPP composition will yield an alkaline AFPS having a pH of about 9, about 9.25, about 9.5, about 9.75, about 10, about 10.25, about 10.5, about 10.75, about 11, about 11.25, about 11.5, about 11.75, about 12, about 12.25, about 12.5, about 12.75, or about 13.

In the preferred embodiment, the high pH AFPS is administered to the meat to be treated. Alternatively, the pH can be lowered to the pH of the meat prior to administration.

### III. Methods of Administration

The AFPS and DPP can be applied to any type of muscle protein which can be “intact” or minced/ground, and can be used in any form e.g., liquid, solid (e.g., as a powder), or semi-solid form. The compositions are prepared as an aqueous suspension or a dry powder. The dry powder may be admixed with water prior to application. Typically, an alkaline AFPS is injected (for example, with a hand or mechanized injector) into a target animal muscle tissue. Alternatively, an alkaline AFPS is directly applied to a target animal muscle tissue by, for example, tumbling, soaking, or mixing of the target animal muscle tissue with the alkaline AFPS. In the case of ground or minced muscle, the AFPS can be mixed into the muscle protein before or shortly after grinding or mincing. Addition rates can vary based on the desired effect but will generally be within the range of 1% above the original target weight up to 100% of the original target weight.

Depending upon the precise application contemplated, the target animal muscle tissue is derived from the same animal type as the source animal muscle tissue from which the alkaline AFPS is derived. Alternatively, the target animal muscle tissue may be derived from a different animal type as the source animal muscle tissue. Typically, the target animal muscle tissue is from reptiles, mammals, seafood, or poultry. Mamalian target animal muscle tissues may be from cattle, pig, sheep, deer, elk, or rabbit.

Since the natural components of the source animal muscle tissue are not lost as would otherwise occur with processes employing a dewatering step, the original nutritional profile of the source tissue is maintained. During conventional dewatering processes, water soluble proteins, amino acids, lipids, and salts, etc., are discarded with the water that is removed from the animal tissue.

By retaining a greater percentage of the starting material in the AFPS than processes which remove the fat and connective tissue using a mechanical and/or acid processing step, and due to the use of fewer processing steps, the cost of making AFPS by alkali treatment is less than the cost of the other methods. This also yields a product that has better capability for increasing moisture content in meat into which it is administered, since the material includes more connective tissue, which has higher water retention than muscle protein, and fat. In one embodiment, the meat to be treated is meat such as lean beef or pork with little to no marbling. The DPP or AFPS is selectively injected into the lean meat to mimic the effect of marbling on taste and juiciness, at a significantly lower cost than lengthy grain feeding of the target animal.

Another advantage of the AFPS is that the high pH of the suspension acts to move the pH away from the isoelectric point, causing an increase in the water holding capacity of the muscle, which enhances juiciness and tenderness.

The alkaline AFPS exhibits the desired properties, when injected, or otherwise applied, into an animal muscle tissue, of increased moisture content, enhanced moisture retention, and uniform moisture distribution. Increased moisture content can be measured, for example, with a testing machine such as an IPac halogen moisture analyzer (Model HB43-S, Mettler-Toledo Inc., Columbus, Ohio) or in a conventional oven by measuring mass before and after drying to determine a mass ratio. To determine uniformity of moisture distribution, samples can be taken from various parts of the injected product and the moisture content analyzed to determine the moisture content of each sample.

The following non-limiting examples are provided to illustrate various aspects of the method and compositions described above. All references are incorporated by reference.

### Example 1

### Preparation of an AFPS

300 grams of coarsely-chopped chicken breast was mixed with 700 grams of water and mixed in a blender (KitcherAid®, Model #KSB56RH; St. Joseph, Mich.) for two minutes on the liquefy setting. The mixture was passed through a hand-held strainer (pore size of approximately 1/16^{th} in.) to remove connective tissue (37 grams). The retained chicken breast suspension (951 grams) contained 5.3% solids. 489 g of water was added to achieve a final solids content of 3.5%. The pH of the mixture was raised to 11.5 by addition of NaOH.

The alkaline aqueous functional protein suspension was injected into boneless skinless chicken breasts using a handheld marinade injector. The chicken breasts were cooked individually to an internal temperature of 160° F. on an electric grill (George Foreman®; Model 9GRSBLK Salton, Inc., Mirimar, Fla.). The results are presented in Table 1.

TABLE 1

| | Breast # | | | |
|---|---|---|---|---|
| | 1 | | | |
| | (Negative | | | |
| | Control) | 2 | 3 | 4 |
| Initial Mass (grams) | 172 | 167 | 168 | 175 |
| Injected Mass (grams) | 172 | 178 | 178 | 187 |
| % Mass Increase after | 0.0% | 6.6% | 6.0% | 6.9% |
| Injection | | | | |
| Cooked Mass | 121 | 135 | 137 | 143 |
| % of Initial Mass Retained | 70.3% | 80.8% | 81.5% | 81.7% |
| after Cooking | | | | |

These data demonstrate that the AFPS-treated chicken breasts increased in weight after injection and had a higher retention of moisture (and were thus ‘juicier’ and had better organoleptic characteristics) than the control.

### Example 2

### Preparation of DPPS

843 g of chicken breast was cubed and then chopped in a food processor (KitchenAid®) for 5 min with 200 g of ice and 599 g water. The resultant mixture was passed through a 1/16^{th} inch mesh screen. The retained connective tissue was discarded and the pass-through (1527 g) was collected and determined to contain 10.2% solids.

The resulting slurry was vacuum-tumble dried using a 5 kg capacity tumble dryer, which was heated with the application of direct propane flame to the exterior of the drum. A vacuum was maintained at 21-27 inches of mercury. The dryer was opened frequently to inspect and evaluate dryness. As the material approached the dry state the temperature of the system was reduced to below 100° F. at the suction line to the vacuum pump. The resulting dried source meat was ground in a coffee grinder (Krups; Medford, Mass.) to produce a fine powder. The final moisture content of the powder was 0.85% by mass.

19 g of the powdered source meat was mixed with 3.3 g of anhydrous sodium hydroxide (NaOH) to achieve a final pH of 10.25. 320 g water was added to the mixture and the resulting suspension was blended and mixed at high speed (KitchenAid®) to create 323 g of AFPS with a final protein content of 5%.

110 g of the AFPS was mixed with 647 g of diced chicken breast pieces, placed into a block pan (Model; Manufacturer; City, State), and emulsified with 9 g of vitamin E oil (KitchenAid®). The AFPS emulsion was mixed with 650 g of diced chicken breast and placed into a block pan to increase the level of vitamin E per portion of chicken.

Both block pans were placed into a compression frame comprising two plates of aluminum, with bolts in all four corners. Compression was achieved by tightening bolts with the block pans between the two aluminum plates to minimize vertical and horizontal expansion during the freezing process. The chicken AFPS was frozen for 12 hours in a chest freezer at approximately 0° F.

The frozen chicken AFPS was removed from the blocks and cut into 100 g portions. The portions were coated with Krusteaz (“Pancake, Biscuit, Baking Mix, All Purpose Mix”; Seattle, Wash.) brand batter, breaded Progresso (“Progresso Bread Crumbs Plain”, General Mills; Minneapolis, Minn.) brand breading mixture, and deep fried in canola oil at approximately 370° F. using a T-Fal brand home size deep fryer (Model No. SERIEF32; T-Fal USA, West Orange, N.J.). The cooked portions were evaluated by tasting. Coating performance was observed to by typical to and equivalent with commercially available products sold in retail stores, evidenced by good adhesion and no instances of “blow-off.” The consensus of the tasters was that the product was less fatty, moister and more typical of a fresh product than typical breaded chicken portions.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

I claim:

1. A method for preparing an alkaline aqueous functional protein suspension (AFPS), comprising the steps of:
(a) mixing a source animal muscle tissue with water;
(b) chopping, grinding, emulsifying and/or mincing the source animal muscle tissue of step (a) to generate an aqueous functional protein suspension (AFPS) comprising muscle and connective tissue protein and fat;
(c) adding water to adjust the solids concentration of the AFPS of step (b) to between about 2% and about 7% protein on a mass-to-mass basis;
(d) alkalinizing the AFPS of step (c) with a strong base to a pH above that of the native source animal muscle tissue,
wherein the process does not include an acid treatment step.

2. The method of claim 1 wherein the source animal muscle tissue is selected from the group consisting of reptiles, mammals, seafood, and poultry.

3. The method of claim 2 wherein the source animal muscle tissue is from a mammal.

4. The method of claim 3 wherein the mammal is selected from the group consisting of cattle, pigs, sheep, deer, elk, and rabbits.

5. The method of claim 1 wherein the step of chopping, grinding, and/or mincing the source animal muscle tissue employs a high shear device.

6. The method of claim 1 wherein a step of separating non-solubilized connective tissue from the chopped, ground, and/or minced source animal muscle tissue mixture is performed following the step of alkalinizing.

7. The method of claim 1, further comprising the step of adding a food additive selected from the group consisting of a fiber, a vitamin, a mineral, a flavoring, an antioxidant, an amino acid, an oil, a weak acid, a weak base, and a buffer.

8. The method of claim 7 wherein the food additive is added after the step of alkalinizing.

9. The method of claim 1 wherein in step (e) the pH is between about pH 9 and about pH 13.

10. An alkaline aqueous functional protein suspension (AFPS), prepared by a process comprising the steps of.
(a) mixing a source animal muscle tissue with water;
(b) chopping, grinding, emulsifying and/or mincing the source animal muscle tissue of step (a) to generate an aqueous functional protein suspension (AFPS) comprising muscle and connective tissue protein and fat;
(c) adding water to adjust the solids concentration of the AFPS of step (b) to between about 2% and about 7% protein on a mass-to-mass basis;
(d) alkalinizing the AFPS of step (c) with a strong base to a pH above that of the native source animal muscle tissue,
wherein the process does not include an acid treatment step.

11. The alkaline AFPS of claim 10 wherein the source animal muscle tissue is selected from the group consisting of reptiles, mammals, seafood, and poultry.

12. The alkaline ASPS of claim 11 wherein the source animal muscle tissue is from a mammal.

13. The alkaline AFPS of claim 12 wherein the mammal is selected from the group consisting of cattle, pigs, sheep, deer, elk, and rabbits.

14. The alkaline AFPS of claim 10 wherein the step of chopping, grinding, and/or mincing the source animal muscle tissue employs a high shear device.

15. The alkaline AFPS of claim 10 wherein the process further comprises the step of separating non-solubilized connective tissue from the chopped, ground, and/or minced source animal muscle tissue mixture following the step of alkalinizing.

16. The alkaline AFPS of claim 10, further comprising a food additive selected from the group consisting of a fiber, a vitamin, a mineral, a flavoring, an antioxidant, an amino acid, an oil, a weak acid, a weak base, and a buffer.

17. The alkaline AFPS of claim 10 wherein the food additive is added after the step of alkalinizing.

18. The alkaline AFPS of claim 10 wherein the pH in step (e) is between about pH 9 and about pH 13.

19. The alkaline AFPS administered into animal muscle tissue.

20. A dry protein powder (DPP) prepared by drying the alkaline AFPS of claim 10 or by addition of dry alkalai to dry meat powder to form the alkaline AFPS of claim 10 upon addition of water.

21. The DPP of claim 20 further comprising one or more dry chemical ingredients selected from the group consisting of an alkaline or other buffer, a phosphate, an amino acid(s), a strong base (such as NaOH), and a salt.

22. The DPP of claim 21 in a kit wherein the dry chemical ingredient is packaged separately from the powdered DPP.

23. The DPP of claim 20, further comprising a food additive selected from the group consisting of a fiber, a vitamin, a mineral, a flavoring, an antioxidant, an amino acid, an oil, a weak acid, a weak base, and a buffer.

24. A method of treating a target animal muscle tissue comprising
(1) adding water to an AFPS or DPP prepared by a process comprising the steps of:
(a) mixing a source animal muscle tissue with water;
(b) chopping, grinding, emulsifying and/or mincing the source animal muscle tissue of step (a) to generate an aqueous functional protein suspension (AFPS);
(c) adding water to adjust the solids concentration of the AFPS of step (b) to between about 2% and about 7% protein on a mass-to-mass basis;
(d) alkalinizing the AFPS of step (c) with a strong base to a pH above that of the native source animal muscle tissue, and
(e) optionally, drying the AFPS to form a dry protein powder (DPP),
(f) alternatively, by addition of dry alkalai to dry meat powder to form the DPP and
(2) applying the alkaline AFPS or DPP to a target animal muscle tissue.

25. The method of claim 24 wherein the AFPS or DPP is applied using a method selected from the group consisting of injecting, tumbling, soaking, and mixing the target animal muscle tissue with the AFPS or DPP
